(19) United States
(12) Patent Application Publication
(10) Pub. No.: US 2024/0154180 A1
(43) Pub. Date: May 9, 2024

(54) ENERGY STORAGE DEVICE AND METHOD FOR MANUFACTURING THE SAME

(71) Applicant: GS Yuasa International Ltd., Kyoto-shi, Kyoto (JP)

(72) Inventors: Yudai KAWASOE, Kyoto (JP); Taisei SEKIGUCHI, Kyoto (JP); Ukyo HARINAGA, Kyoto (JP)

(21) Appl. No.: 18/279,959

(22) PCT Filed: Mar. 1, 2022
(86) PCT No.: PCT/JP2022/008492

§ 371 Date: Sep. 1, 2023

(30) Foreign Application Priority Data
Mar. 4, 2021 (JP) 2021-034797

(51) Int. Cl. H01M 10/0587; H01M 50/431; H01M 50/443

(52) U.S. Cl. CPC H01M 10/0587; H01M 50/431; H01M 50/443

(57) ABSTRACT

An energy storage device according to one aspect of the present invention includes an electrode assembly obtained by winding a first separator, a first electrode, a second separator, and a second electrode layered in this order, without including a winding core, where at least a part of the first separator and at least a part of the second separator are bonded to each other at the innermost periphery of the electrode assembly, the first separator includes a layer including inorganic particles, and the layer including the inorganic particles is disposed at the innermost peripheral surface of the electrode assembly.

### TECHNICAL FIELD

The present invention relates to an energy storage device and a method for manufacturing the energy storage device.

### BACKGROUND ART

Energy storage devices (such as a secondary battery and a capacitor) that can be charged and discharged are used for various devices, e.g., vehicles such as electric vehicles and household electric appliances. As an energy storage device, there is known an energy storage device including a wound-type electrode assembly obtained by winding a band-shaped positive electrode and a band-shaped negative electrode layered on one another with a band-shaped separator interposed therebetween. Such an electrode assembly is housed together with an electrolyte in a case to construct an energy storage device.

Patent Document 1 describes an energy storage device including a winding core and a wound body obtained by winding, around the winding core, a positive electrode, a negative electrode, and two separators that are layered, where at least one of the two separators is welded and fixed to the winding core.

### PRIOR ART DOCUMENT

### Patent Document

Patent Document 1: JP-A-2013-191467

### SUMMARY OF THE INVENTION

### Problems to be Solved by the Invention

In the energy storage device described in Patent Document 1, the winding core is disposed at the center of the wound-type electrode assembly (wound body) as mentioned above. In contrast, the use of an electrode assembly without a winding core is conceivable in order to achieve, for example, the increased capacity of the energy storage device. The wound-type electrode assembly including no winding core can be manufactured by, for example, winding a positive electrode, a negative electrode, and a separator around a spindle of a winding device, and removing the obtained electrode assembly from the spindle. In removing the electrode assembly from the spindle, however, it may be difficult to remove the electrode assembly due to the friction between the surface of the spindle and the innermost peripheral surface of the electrode assembly. When the electrode assembly fails to be easily removed from the spindle, the productivity of the energy storage device is decreased. In addition, in removing the electrode assembly from the spindle, the large friction between the surface of the spindle and the innermost peripheral surface of the electrode assembly makes the electrode assembly likely to cause winding deviations, which may degrade the performance and reliability of the energy storage device. In particular, when the two separators are bonded to each other by welding at the innermost periphery of the electrode assembly, there is a strong tendency to make it more difficult to remove the electrode assembly due to thermal shrinkage of the separators.

The present invention has been made in view of the foregoing circumstances, and an object of the present invention is to provide an energy storage device including a wound-type electrode assembly including no winding core, which is high in productivity, and a method for manufacturing such an energy storage device.

### Means for Solving the Problems

An energy storage device according to one aspect of the present invention includes an electrode assembly obtained by winding a first separator, a first electrode, a second separator, and a second electrode layered in this order, without including a winding core, where at least a part of the first separator and at least a part of the second separator are bonded to each other at the innermost periphery of the electrode assembly, the first separator includes a layer including inorganic particles, and the layer including the inorganic particles is disposed at the innermost peripheral surface of the electrode assembly.

A method for manufacturing an energy storage device according to another aspect of the present invention includes: bonding at least a part of a tip part of a band-shaped first separator including a layer including inorganic particles and at least a part of a tip part of a band-shaped second separator to each other; disposing the tip part of the first separator and the tip part of the second separator on a spindle such that the layer including the inorganic particles has contact with the spindle; winding the first separator, a first electrode, the second separator, and a second electrode layered in this order with the use of the spindle; and removing the obtained electrode assembly from the spindle.

### Advantages of the Invention

According to an aspect of the present invention, an energy storage device including a wound-type electrode assembly including no winding core, which is high in productivity, and a method for manufacturing such an energy storage device can be provided.

### BRIEF DESCRIPTION OF THE DRAWINGS

FIG. 1 is a see-through perspective view illustrating an energy storage device according to a first embodiment.

FIG. 2 is a schematic partial cross-sectional view illustrating an electrode assembly in FIG. 1.

FIG. 3 is a partially enlarged view of the electrode assembly in FIG. 2.

FIG. 4 is a first explanatory view illustrating a process of manufacturing the electrode assembly in FIG. 2.

FIG. 5 is a second explanatory view illustrating a process of manufacturing the electrode assembly in FIG. 2.

FIG. 6 is a schematic partial cross-sectional view illustrating an electrode assembly according to a second embodiment.

FIG. 7 is a partially enlarged view of the electrode assembly in FIG. 6.

FIG. 8 is a first explanatory view illustrating a process of manufacturing the electrode assembly in FIG. 6.

FIG. 9 is a second explanatory view illustrating a process of manufacturing the electrode assembly in FIG. 6.

FIG. 10 is a schematic cross-sectional view illustrating an electrode assembly according to a third embodiment.

FIG. 11 is a schematic diagram illustrating an embodiment of an energy storage apparatus including a plurality of energy storage devices.

### MODE FOR CARRYING OUT THE INVENTION

First, outlines of an energy storage device and a method for manufacturing the energy storage device, disclosed in the present specification, will be described.

An energy storage device according to one aspect of the present invention includes an electrode assembly obtained by winding a first separator, a first electrode, a second separator, and a second electrode layered in this order, without including a winding core, where at least a part of the first separator and at least a part of the second separator are bonded to each other at the innermost periphery of the electrode assembly, the first separator includes a layer including inorganic particles, and the layer including the inorganic particles is disposed at the innermost peripheral surface of the electrode assembly.

The energy storage device is an energy storage device including a wound-type electrode assembly no winding core, which is high in productivity. Although the reason why such an effect is produced is not clear, the following reason is presumed. In the energy storage device, the layer including the inorganic particles, of the first separator, is disposed at the innermost peripheral surface of the electrode assembly, thus resulting in a small friction between the surface of a spindle and the innermost peripheral surface of the electrode assembly when the electrode assembly is manufactured with the use of the spindle. Accordingly, the energy storage device is high in productivity, because the electrode assembly can be removed from the spindle easily and with winding deviations kept from being caused. In addition, the energy storage device keeps the electrode assembly from causing winding deviations, also because at least parts of the two separators are bonded to each other at the innermost periphery of the electrode assembly.

It is to be noted that one of the “first electrode” and the “second electrode” serves as a positive electrode, whereas the other thereof serves as a negative electrode.

The bonding between the first separator and the second separator is preferably welding. For example, when the separators are bonded to each other with the use of an adhesive member such as an adhesive or a tape, there is fear that a difference in thickness between the bonded part and the non-bonded part may cause deviations and the like at the time of winding. In contrast, bonding the separators to each other by welding reduces the difference in thickness, allows winding deviations and the like to be further suppressed, and further enhances the productivity. In the case of bonding the separators to each other by welding, however, there is a strong tendency to make it difficult to remove the electrode assembly from the spindle due to thermal shrinkage of the separators as described above, but in the energy storage device, the layer including the inorganic particles is disposed at the innermost peripheral surface of the electrode assembly, and thus, the electrode assembly can be easily removed from the spindle even in such a case, which is high in productivity.

Preferably, the first separator further includes a substrate layer containing a resin as a main component, and at least a part of the substrate layer and at least a part of the second separator are bonded to each other at the innermost periphery of the electrode assembly. For example, when the content of the inorganic particles is high, the layer including the inorganic particles may fail to be bonded with sufficient strength by welding or the like. When the first separator includes the substrate layer besides the layer including the inorganic particles, the two separators can be bonded to each other easily and with sufficient strength by welding the substrate layer and the second separator.

The layer including the inorganic particles preferably contains a resin as a main component. With such a configuration, the layer including the inorganic particles, of the first separator, and the second separator can be bonded to each other easily and with sufficient strength by welding or the like.

It is to be noted that the “main component” refers to a component that is the highest in content on a mass basis. Although not to be considered particularly limited, the main component is, for example, a component that is 50% by mass or more in content.

The first separator for the first turn and the first separator for the second turn, based on the innermost circumference, are bonded to each other. In the case of such bonding performed, the winding of the electrode assembly becomes less likely to be loosened, and winding deviations and the like can be further kept from being caused.

A method for manufacturing an energy storage device according to another aspect of the present invention includes: bonding at least a part of a tip part of a band-shaped first separator including a layer including inorganic particles and at least a part of a tip part of a band-shaped second separator to each other; disposing the tip part of the first separator and the tip part of the second separator on a spindle such that the layer including the inorganic particles has contact with the spindle; winding the first separator, a first electrode, the second separator, and a second electrode layered in this order with the use of the spindle; and removing the obtained electrode assembly from the spindle.

In accordance with the manufacturing method, the electrode assembly is fabricated by winding, with the first separator disposed such that the layer including the inorganic particles has contact with the spindle. Thus, the obtained electrode assembly can be removed from the spindle easily and with winding deviations kept from being caused, which is high in productivity. In addition, in accordance with the manufacturing method, the electrode assembly with winding deviations kept from being caused can be obtained by winding with at least parts of the tip parts of the two separators bonded to each other.

An energy storage device according to an embodiment of the present invention, a method for manufacturing the energy storage device, an energy storage apparatus, and other embodiments will be described in detail. The names of the respective constituent members (respective constituent elements) for use in the respective embodiments may be different from the names of the respective constituent members (respective elements) for use in the background art.

### Energy Storage Device: First Embodiment

An energy storage device according to an embodiment of the present invention includes: an electrode assembly including a positive electrode, a negative electrode, and a separator; a nonaqueous electrolyte; and a case that houses the electrode assembly and the nonaqueous electrolyte. As described in detail later, the electrode assembly is a wound-type electrode assembly obtained by winding a positive electrode and a negative electrode layered with a separator interposed therebetween. The nonaqueous electrolyte is present to be contained in the positive electrode, the negative electrode, and the separator. A nonaqueous electrolyte secondary battery will be described as an example of the energy storage device.

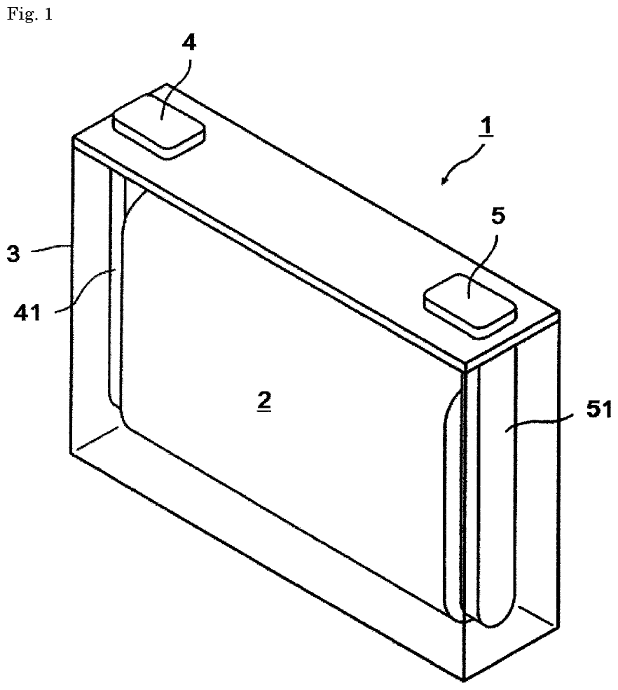

FIG. 1 shows an energy storage device 1 as an example of a nonaqueous electrolyte secondary battery. It is to be noted that FIG. 1 is a view illustrating the inside of a case in a perspective manner. An electrode assembly 2 including a positive electrode and a negative electrode wound with a separator interposed therebetween is housed in a prismatic battery case 3. The positive electrode is electrically connected to a positive electrode terminal 4 via a positive electrode lead 41. The negative electrode is electrically connected to a negative electrode terminal 5 via a negative electrode lead 51. In addition, a nonaqueous electrolyte (not shown) is housed together with the electrode assembly 2 in the case 3.

### (Electrode Assembly)

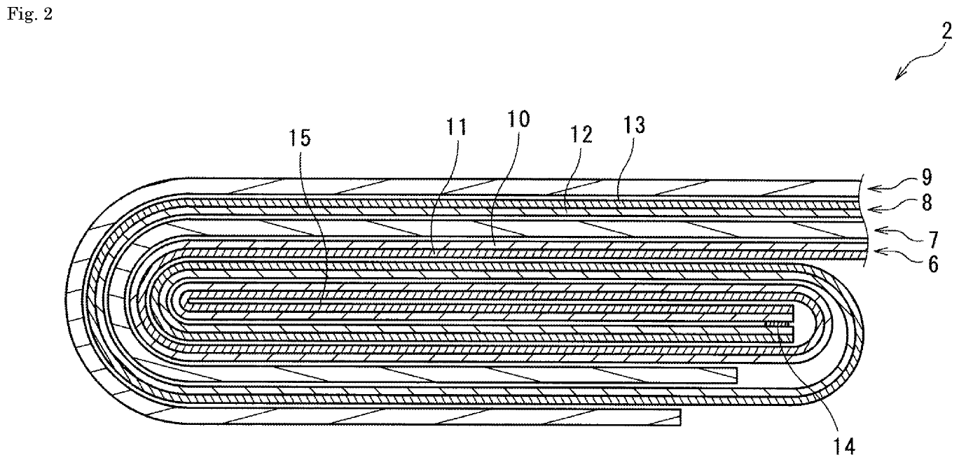

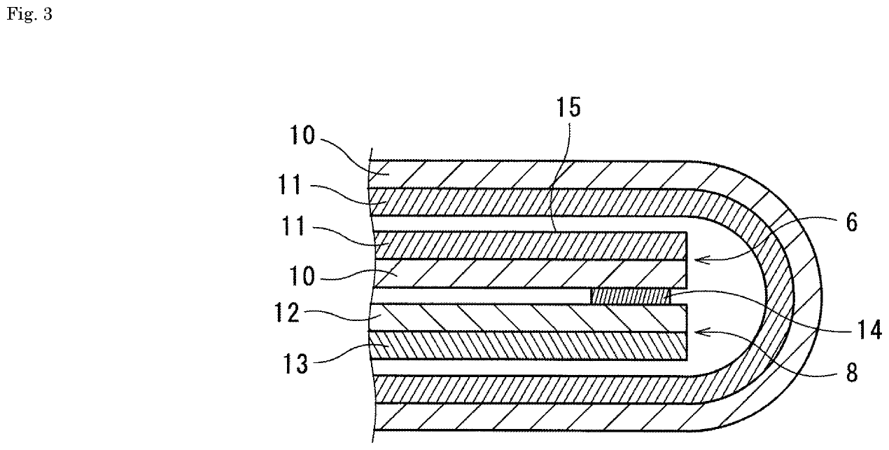

Hereinafter, the structure of the electrode assembly 2 according to the first embodiment of the present invention will be described in detail. As shown in FIG. 2, the electrode assembly 2 is a wound-type electrode assembly obtained by winding a first separator 6, a negative electrode 7 as a first electrode, a second separator 8, and a positive electrode 9 as a second electrode layered on each other in this order. In addition, the electrode assembly 2 has no winding core. The central part of the electrode assembly 2 may have a cavity part, or may have substantially no cavity part. In FIG. 2, for the sake of description, the first separator 6, the negative electrode 7, the second separator 8, and the positive electrode 9, which are adjacent to each other, are illustrated slightly away from each other, but in practice, these adjacent separators and electrodes are layered in contact with each other. The same applies to FIGS. 3 to 10.

The first separator 6 has a band shape. The first separator 6 includes a layer 11 including inorganic particles. According to the present embodiment, the first separator 6 further includes a substrate layer 10 layered on the layer 11 including the inorganic particles. As described above, the first separator 6 has a two-layer structure.

The substrate layer 10 is typically a porous layer containing a resin as a main component. The resin is preferably a thermoplastic resin. The content of the resin in the substrate layer 10 is preferably 50% by mass or more and 100% by mass or less, more preferably 70% by mass or more, still more preferably 90% by mass or more, particularly preferably 99% by mass or more. The content of the resin in the substrate layer 10 is equal to or more than the lower limit mentioned above, thereby improving the adhesiveness, particularly the weldability. The substrate layer 10 may be a layer composed substantially only of a resin.

Examples of the form of the substrate layer 10 include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material of the substrate layer 10, a polyolefin such as polyethylene (PE) or polypropylene (PP) is preferable from the viewpoint of a shutdown function, and polyimide, aramid or the like is preferable from the viewpoint of resistance to oxidation and decomposition. As the substrate layer 10, a material obtained by combining these resins may be used. Preferred examples of the substrate layer 10 include a layer that has a single layer structure of PE and a layer that has a three-layer structure of PP/PE/PP.

The average thickness of the substrate layer 10 is preferably 1 μm or more and 30 μm or less, more preferably 3 μm or more and 20 μm or less. The average thickness of the substrate layer 10 falls within the range mentioned above, thereby allowing sufficient weldability, strength, and the like to be produced. The average thickness of the substrate layer 10 refers to the average value of thicknesses measured at any five points of the substrate layer 10. The same applies to the average thicknesses of the other layers and the like.

The layer 11 including the inorganic particles is preferably, for example, a layer composed of inorganic particles and a binder. The inorganic particles are particles composed of an inorganic compound. Examples of the inorganic compound include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compound, simple substances or complexes of these substances may be used alone, or two or more thereof may be used in mixture. Among these inorganic compounds, the silicon oxide, aluminum oxide, barium oxide, boehmite, or aluminosilicate is preferable from viewpoints such as the safety and friction reduction of the energy storage device. The inorganic particles preferably have a mass loss of 5% or less in the case of temperature increase from room temperature to 500° C. under the air atmosphere of 1 atm, and more preferably have a mass loss of 5% or less in the case of temperature increase from room temperature to 800° C.

According to the present embodiment, the main component in the layer 11 including the inorganic particles is preferably inorganic particles. The content of the inorganic particles in the layer 11 including the inorganic particles is preferably 50% by mass or more and 99% by mass or less, more preferably 70% by mass or more and 97% by mass or less. The content of the inorganic particles in the layer 11 including the inorganic particles is equal to or more than the lower limit mentioned above, thereby allowing, for example, the friction between the surface of a spindle and the innermost peripheral surface of the electrode assembly 2 to be sufficiently reduced. In addition, the content of the inorganic particles in the layer 11 including the inorganic particles is equal to or less than the upper limit mentioned above, thereby causing, for example, the presence of a sufficient binder or the like to sufficiently fix the inorganic particles.

The average particle size of the inorganic particles is, for example, preferably 0.05 μm or more and 5 μm or less, more preferably 0.1 μm or more and 3 μm or less. The average particle size of the inorganic particles falls within the range mentioned above, thereby allowing, for example, the friction between the surface of a spindle and the innermost peripheral surface of the electrode assembly 2 to be sufficiently reduced. The “average particle size” of the inorganic particles means the average value of the Feret's diameters of arbitrary fifty particles in a scanning electron microscope (SEM) image.

Examples of the binder in the layer 11 including the inorganic particles include: thermoplastic resins such as fluororesin (polytetrafluoroethylene (PTFE), polyvinylidene fluoride (PVDF), etc.), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers. The content of the binder in the layer 11 including the inorganic particles is, for example, preferably 1% by mass or more and 50% by mass or less, more preferably 3% by mass or more and 30% by mass or less.

The average thickness of the layer 11 including the inorganic particles is preferably 1 μm or more and 30 μm or less, more preferably 2 μm or more and 20 μm or less. In some aspects, the average thickness of the layer 11 including the inorganic particles may be, for example, 15 μm or less, typically 10 μm or less (for example, 5 μm or less). The average thickness of the layer 11 including the inorganic particles falls within the range mentioned above, thereby allowing, for example, the friction between the surface of a spindle and the innermost peripheral surface of the electrode assembly 2 to be sufficiently reduced.

The porosity of the first separator 6 is preferably 80% by volume or less from the viewpoint of strength, and is preferably 20% by volume or more from the viewpoint of discharge performance. The “porosity” herein is a volume-based value, which means a value measured with a mercury porosimeter.

As with the first separator 6, the second separator 8 has a band shape. According to the present embodiment, the second separator 8 has a substrate layer 12, and a layer 13 including inorganic particles, layered on the substrate layer 12. As described above, the second separator 8 has a two-layer structure. The specific and preferred forms of the substrate layer 12 and layer 13 including the inorganic particles, included in the second separator 8, are the same as those of the substrate layer 10 and layer 11 including the inorganic particles, included in the first separator 6. The first separator 6 and the second separator 8 may have the same material, shape, size, and the like, or may differ in material, shape, size, or the like.

The negative electrode 7 and the positive electrode 9 each also have a band shape. The specific and preferred forms of the negative electrode 7 and positive electrode 9 will be described later. It is to be noted that the negative electrode 7 and the positive electrode 9 are each illustrated as a single layer in FIG. 2 and the like, but each typically have a layer structure including multiple layers as described later.

At the innermost periphery of the electrode assembly 2, at least a part of the first separator 6 and at least a part of the second separator 8 are bonded to each other. Specifically, as shown in FIG. 3, the substrate layer 10 of the first separator 6 and the substrate layer 12 of the second separator 8 are bonded to each other at tip parts 14 of the innermost periphery. The innermost circumference of the electrode assembly 2 is composed of only the first separator 6 and the second separator 8, and the first separator 6 and the second separator 8 are layered such that the substrate layers 10 and 12 face each other. The method for bonding the first separator 6 and the second separator 8 to each other at the tip parts 14 is not particularly limited, and for example, may be a method of using an adhesive member such as an adhesive or a tape, but welding is preferable. Welding is a method of bonding by melting and solidifying a member, and a known method such as ultrasonic welding or thermal welding can be employed. In particular, bonding by ultrasonic welding or thermal welding is preferable from the viewpoints such as precisely welding a predetermined range. In addition, when the substrate layer 10 of the first separator 6 and the substrate layer 12 of the second separator 8 both contain a resin (thermoplastic resin) as a main component, these substrate layers 10 and 12 are layered so as to face each other, thereby causing high-strength bonding by welding.

In addition, the innermost circumference of the electrode assembly 2 is composed of the first separator 6 and the second separator 8 layered such that the respective substrate layers 10 and 12 face each other, and the electrode assembly 2 is wound such that the first separator 6 is disposed on the inner side. Thus, the layer 11 including the inorganic particles, of the first separator 6, is disposed at the innermost peripheral surface 15 of the electrode assembly 2. The innermost peripheral surface 15 is the layer 11 including the inorganic particles as described above, thereby allowing the friction between the surface of a spindle and the innermost peripheral surface of the electrode assembly 2 to be sufficiently reduced.

Further, in the electrode assembly 2, the negative electrode 7 is disposed between the first separator 6 and the second separator 8, whereas the positive electrode 9 is disposed outside the second separator 8, for the second turn based on the innermost circumference (with the innermost circumference as the first turn). Further, the first separator 6, the negative electrode 7, the second separator 8, and the positive electrode 9 layered in this order are wound for the second and subsequent turns. In the electrode assembly 2, the layer 11 including the inorganic particles, of the first separator 6, and the layer 13 including the inorganic particles of the second separator 8, are disposed so as to face each other on both surfaces of the positive electrode 9.

### (Positive Electrode)

The positive electrode has a positive substrate and a positive active material layer disposed directly on the positive substrate or over the positive substrate with an intermediate layer interposed therebetween. The positive active material layer may be provided only on one surface of the positive substrate, or may be provided on each of both surfaces thereof, but is preferably provided on each of the both surfaces.

The positive substrate has conductivity. Whether the positive substrate has “conductivity” or not is determined with the volume resistivity of 10⁷ Ω·cm measured in accordance with JIS-H-0505 (1975) as a threshold. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and A1N30 specified in JIS-H-4000 (2014) or JIS-1-14160 (2006).

The average thickness of the positive substrate is preferably 3 μm or more and 50 μm or less, more preferably 5 μm or more and 40 μm or less, still more preferably 8 μm or more and 30 μm or less, particularly preferably 10 μm or more and 25 μm or less. The average thickness of the positive substrate falls within the range mentioned above, thereby making it possible to increase the energy density per volume of the energy storage device while increasing the strength of the positive substrate.

The intermediate layer is a layer arranged between the positive substrate and the positive active material layer. The intermediate layer includes a conductive agent such as carbon particles to reduce contact resistance between the positive substrate and the positive active material layer. The configuration of the intermediate layer is not particularly limited, and includes, for example, a binder and a conductive agent.

The positive active material layer includes a positive active material. The positive active material layer contains optional components such as a conductive agent, a binder (binding agent), a thickener, a filler, or the like as necessary.

The positive active material can be appropriately selected from known positive active materials. As the positive active material for a lithium ion secondary battery, a material capable of occluding and releasing lithium ions is typically used. Examples of the positive active material include lithium-transition metal composite oxides that have an α-NaFeO₂-type crystal structure, lithium-transition metal composite oxides that have a spinel-type crystal structure, polyanion compounds, chalcogenides, and sulfur. Examples of the lithium-transition metal composite oxides that have an α-NaFeO₂-type crystal structure include Li[Liₓ,Ni₍₁₋ₓ₎]O₂ (0≤x≤0.5), Li[LiₓNi_{y}Co_{(1-x-y)}]O₂ (0≤x≤0.5, 0<y<1), Li[LiₓCo₍₁₋ₓ₎]O₂ (0≤x<0.5), Li[LiₓNi_{y}Mn_{(1-x-y)}]O₂ (0≤x≤0.5, 0<y<1), Li[Liₓ,Ni_{y}Mn_{β}Co_{(1-x-y-β)}]O₂ (0≤x≤0.5, 0<y, 0<β, 0.5<y+β<1), and Li[LiₓNi_{y}CoβAl_{(1-x-y-β)}]O₂ (0≤x<0.5, 0<y, 0<β, 0.5<y+β<1). Examples of the lithium-transition metal composite oxides that have a spinel-type crystal structure include LiₓMn₂O₄ and LiₓNi_{y}Mn_{(2-y)}O₄. Examples of the polyanion compounds include LiFePO₄, LiMnPO₄, LiNiPO₄, LiCoPO₄, Li₃V₂(PO₄)₃, Li₂MnSiO4, and Li₂CoPO₄F. Examples of the chalcogenides include a titanium disulfide, a molybdenum disulfide, and a molybdenum dioxide. Some of atoms or polyanions in these materials may be substituted with atoms or anion species composed of other elements. The surfaces of these materials may be coated with other materials. In the positive active material layer, one of these materials may be used singly, or two or more thereof may be used in mixture.

The positive active material is typically particles (powder). The average particle size of the positive active material is preferably 0.1 μm or more and 20 μm or less, for example. By setting the average particle size of the positive active material to be equal to or more than the lower limit mentioned above, the positive active material is easily manufactured or handled. By setting the average particle size of the positive active material to be equal to or less than the upper limit mentioned above, the electron conductivity of the positive active material layer is improved. It is to be noted that in the case of using a composite of the positive active material and another material, the average particle size of the composite is regarded as the average particle size of the positive active material.

A crusher, a classifier, or the like is used in order to obtain a powder with a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As the classification method, a sieve, a wind classifier, or the like is used both in dry manner and in wet manner, if necessary.

The content of the positive active material in the positive active material layer is preferably 50% by mass or more and 99% by mass or less, more preferably 70% by mass or more and 98% by mass or less, still more preferably 80% by mass or more and 95% by mass or less. When the content of the positive active material falls within the range mentioned above, a balance can be achieved between the increased energy density and productivity of the positive active material layer.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used singly, or two or more thereof may be used in mixture. In addition, these materials may be used in combination. For example, a material carbon black combined with a CNT may be used. Among these materials, carbon black is preferable from the viewpoints of electron conductivity and coatability, and in particular, acetylene black is preferable.

The content of the conductive agent in the positive active material layer is preferably 1% by mass or more and 10% by mass or less, more preferably 3% by mass or more and 9% by mass or less. The content of the conductive agent falls within the range mentioned above, thereby allowing the energy density of the energy storage device to be increased.

Examples of the binder include: thermoplastic resins such as fluororesin (polytetrafluoroethylene (PTFE), polyvinylidene fluoride (PVDF), etc.), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 3% by mass or more and 9% by mass or less. The content of the binder falls within the range mentioned above, thereby allowing the active material to be stably held.

Examples of the thickener include polysaccharide polymers such as a carboxymethylcellulose (CMC) and a methylcellulose. When the thickener has a functional group that is reactive with lithium and the like, the functional group may be deactivated by methylation or the like in advance.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

### (Negative Electrode)

The negative electrode has a negative substrate and a negative active material layer disposed directly on the negative substrate or over the negative substrate with an intermediate layer interposed therebetween. The negative active material layer may be provided only on one surface of the negative substrate, or may be provided on each of both surfaces thereof, but is preferably provided on each of the both surfaces. The configuration of the intermediate layer is not particularly limited, and for example, can be selected from the configurations exemplified for the positive electrode.

The negative substrate has conductivity. As the material of the negative substrate, a metal such as copper, nickel, stainless steel, nickel-plated steel, or aluminum, an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include a rolled copper foil and an electrolytic copper foil.

The average thickness of the negative substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate falls within the range mentioned above, the energy density per volume of the energy storage device can be increased while increasing the strength of the negative substrate.

The negative active material layer contains a negative active material. The negative active material layer contains optional components such as a conductive agent, a binder, a thickener, and a filler, if necessary. The optional components such as a conductive agent, a binder, a thickener, and a filler can be selected from the materials exemplified for the positive electrode.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non-graphitic carbon are preferable. In the negative active material layer, one of these materials may be used singly, or two or more of these materials may be mixed and used.

The term “graphite” refers to a carbon material in which an average lattice distance (d₀₀₂) of the (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material that has stable physical properties can be obtained.

The term “non-graphitic carbon” refers to a carbon material in which the average lattice distance (d₀₀₂) of the (002) plane determined by the X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the “discharged state” means a state discharged such that lithium ions that can be occluded and released in association with charge-discharge are sufficiently released from the carbon material as the negative active material. For example, the “discharged state” refers to a state where an open circuit voltage is 0.7 V or higher in a monopolar battery that has, for use as a working electrode, a negative electrode containing a carbon material as a negative active material, and has metal Li for use as a counter electrode.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

The negative active material is typically particles (powder). The average particle size of the negative active material can be, for example, 1 nm or more and 100 μm or less. When the negative active material is a carbon material, a titanium-containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to be equal to or greater than the above lower limit, the negative active material is easily produced or handled. By setting the average particle size of the negative active material to be equal to or less than the above upper limit, the electron conductivity of the positive active material layer is improved. A crusher, a classifier, or the like is used in order to obtain a powder with a predetermined particle size. The crushing method and the powder classification method can be selected from, for example, the methods exemplified for the positive electrode. When the negative active material is a metal such as metal Li, the negative active material may have the form of a foil.

The content of the negative active material in the negative active material layer is preferably 60% by mass or more and 99% by mass or less, and more preferably 90% by mass or more and 98% by mass or less. When the content of the negative active material is in the above range, it is possible to achieve both high energy density and productivity of the negative active material layer.

### (Nonaqueous Electrolyte)

The nonaqueous electrolyte can be appropriately selected from known nonaqueous electrolytes. For the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these examples, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these examples, EMC is preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When the cyclic carbonate and the chain carbonate are used in combination, a volume ratio of the cyclic carbonate to the chain carbonate (cyclic carbonate:chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium clifluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these salts, an inorganic lithium salt is preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, and particularly preferably 0.7 mol/dm³ or more and 1.5 mol/dm³ or less. When the content of the electrolyte salt is in the above range, it is possible to increase the ionic conductivity of the nonaqueous electrolyte solution.

The nonaqueous electrolyte solution may contain an additive, besides the nonaqueous solvent and the electrolyte salt. Examples of the additive include halogenated carbonic acid esters such as fluoroethylene carbonate (FEC) and clifluoroethylene carbonate (DFEC); oxalic acid salts such as lithium bis(oxalate)borate (LiBOB), lithium clifluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, particularly preferably 0.3% by mass or more and 3% by mass or less, with respect to a total mass of the nonaqueous electrolyte solution. The content of the additive falls within the above range, thereby making it possible to improve capacity retention performance or cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from any material with ionic conductivity, which is solid at normal temperature (for example, 15° C. to 25° C.), such as lithium, sodium and calcium. Examples of the solid electrolyte include sulfide solid electrolytes, oxide solid electrolytes, oxynitride solid electrolytes, and polymer solid electrolytes.

Examples of the lithium ion secondary battery include Li₂S—P₂S₅, LiI—Li₂S—P₂S₅, and Li₁₀Ge—P₂S₁₂ as the sulfide solid electrolyte.

### <Method for Manufacturing Energy Storage Device>

A method for manufacturing an energy storage device according to an embodiment of the present invention includes: bonding at least a part of a tip part of a band-shaped first separator including a layer including inorganic particles and at least a part of a tip part of a band-shaped second separator to each other (bonding step); disposing the tip part of the first separator and the tip part of the second separator on a spindle such that the layer containing the inorganic particles has contact with the spindle (disposing step); winding the first separator, a first electrode, the second separator, and a second electrode layered in this order with the use of the spindle (winding step); and removing the obtained electrode assembly from the spindle (removing step).

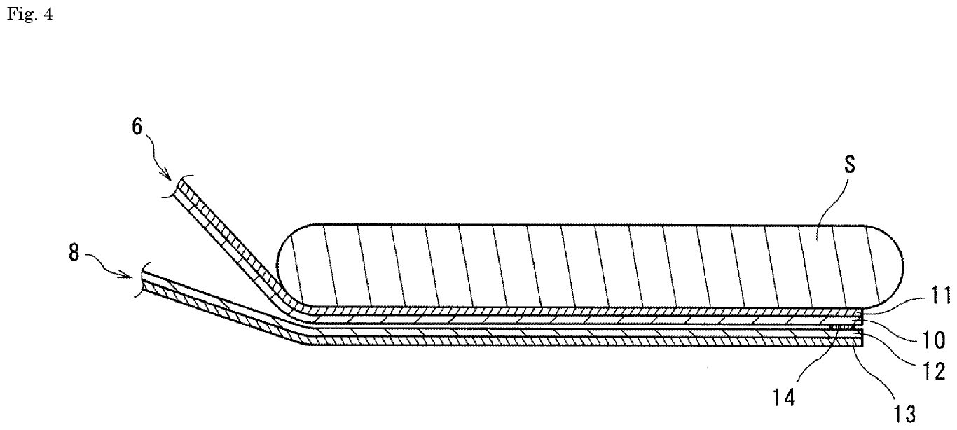

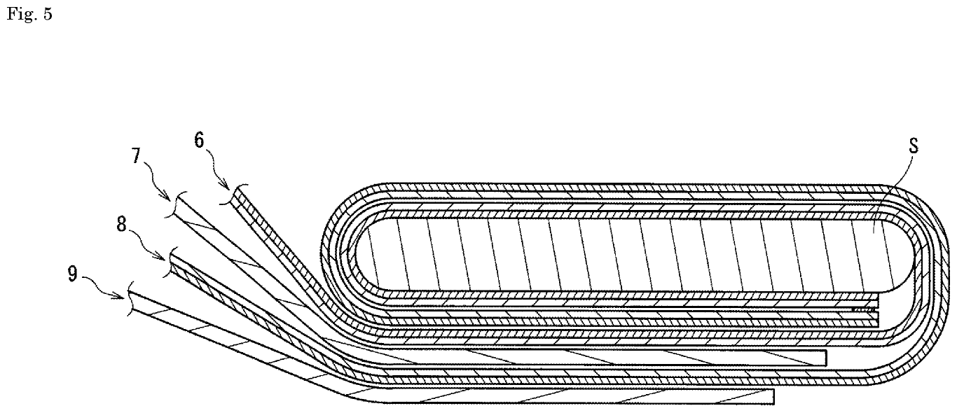

The electrode assembly can be manufactured through the bonding step, the disposing step, the winding step, and the removing step. Hereinafter, with a method for manufacturing the electrode assembly in FIG. 2 as an example, the respective steps will be described in detail with reference to FIGS. 4 and 5 as appropriate.

### (Bonding Step)

In this step, at least a part of the tip part of the band-shaped first separator 6 including the layer 11 including the inorganic particles and at least a part of the tip part of the band-shaped second separator 8 are bonded. Specifically, according to the present embodiment, the substrate layer 10 of the first separator 6 and the substrate layer 12 of the second separator 8 are allowed to face each other, and the tip parts 14 are bonded to each other, with the tips of the both separators 6 and 8 aligned with each other (see FIG. 4). The specific method for bonding is not particularly limited, welding as described above is preferable, and particularly, bonding by ultrasonic welding or thermal welding is preferable.

### (Disposing Step)

In this step, the tip part of the first separator 6 and the tip part of the second separator 8 are disposed on a spindle S of a winding device such that the layer 11 including the inorganic particles, of the first separator 6, has contact with the spindle S (see FIG. 4). The method for fixing the first separator 6 and the second separator 8 to the spindle S is not particularly limited. For example, the first separator 6 and the second separator 8 may be fixed to the spindle S by pressing the tip part of the first separator 6 and the tip part of the second separator 8 against the spindle S with the use of a pressing member (for example, a roller, a pinch, a pressing plate, or the like), not illustrated. Alternatively, the tip part of the first separator 6 and the tip part of the second separator 8 may be sucked and then fixed to the spindle S with the use of a sucking mechanism, not illustrated. As the winding device, a conventionally known winding device for manufacturing a wound-type electrode assembly of an energy storage device can be used.

It is to be noted that the order of the bonding step and the disposing step is not particularly limited. More specifically, after bonding at least a part of the tip part of the first separator 6 and at least a part of the tip part of the second separator 8 to each other, these bonded tip parts may be disposed on the spindle S, or after disposing the tip part of the first separator 6 and the tip part of the second separator 8 on the spindle, at least parts of these tip parts may be bonded to each other. The winding step is, however, performed after both the bonding step and the disposing step.

### (Winding Step)

In this step, the spindle S is rotated to wind the first separator 6, the negative electrode 7 as a first electrode, the second separator 8, and the positive electrode 9 as a second electrode, layered in this order. Further, as shown in FIG. 4, winding for the first turn is performed with only the first separator 6 and the second separator 8 disposed, and as shown in FIG. 5, for the second turn, the negative electrode 7 is disposed between the first separator 6 and the second separator 8, and the positive electrode 9 is disposed outside the second separator 8. Then, for the second and subsequent turns, the first separator 6, the negative electrode 7, the second separator 8, and the positive electrode 9, layered in this order, are wound.

### (Removing Step)

In this step, the electrode assembly (the wound body of the first separator 6, negative electrode 7, second separator 8, and positive electrode 9) obtained in the winding step is removed from the spindle S. In other words, the spindle S located at the central part of the obtained electrode assembly is pulled out. Thus, the electrode assembly 2 in FIG. 2 without any winding core (central core) is obtained.

In accordance with the manufacturing method, the electrode assembly is fabricated by disposing and then winding the layer 11 including the inorganic particles at the innermost peripheral surface in contact with the spindle S. Thus, in the removing step, the electrode assembly 2 can be removed from the spindle S easily and with winding deviations kept from being caused, which is high in productivity. In addition, in the manufacturing method, the tip parts 14 of the two separators are bonded to each other, thereby allowing the electrode assembly 2 to be kept from causing winding deviations.

(Other steps)

The method for manufacturing the energy storage device may include, besides the steps mentioned above, other steps that are similar to those of conventionally known methods for manufacturing energy storage devices. The manufacturing method includes, for example, preparing a nonaqueous electrolyte, and housing the electrode assembly and the nonaqueous electrolyte in a case. In addition, the manufacturing method may include preparing each of the first separator, second separator, first electrode, and second electrode. The first separator, the second separator, the first electrode, and the second electrode may be commercially available products for use, or may be manufactured by conventionally known methods.

### <Energy Storage Device: Second Embodiment>

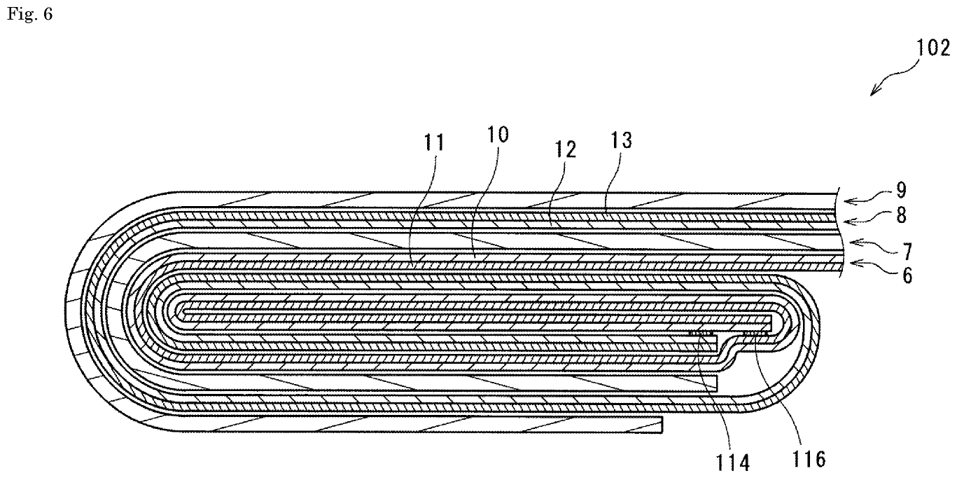

An energy storage device according to a second embodiment of the present invention includes an electrode assembly 102 shown in FIG. 6. The energy storage device according to the second embodiment is the same as the energy storage device according to the first embodiment, except for including the electrode assembly 102 in place of the electrode assembly 2.

As shown in FIG. 6, the electrode assembly 102 is a wound-type electrode assembly obtained by winding a first separator 6, a negative electrode 7 as a first electrode, a second separator 8, and a positive electrode 9 as a second electrode layered on each other in this order. In addition, the electrode assembly 102 has no winding core. The specific structures of the first separator 6, negative electrode 7, second separator 8, and positive electrode 9 included in the electrode assembly 102 are the same as those included in the electrode assembly 2 in FIG. 2.

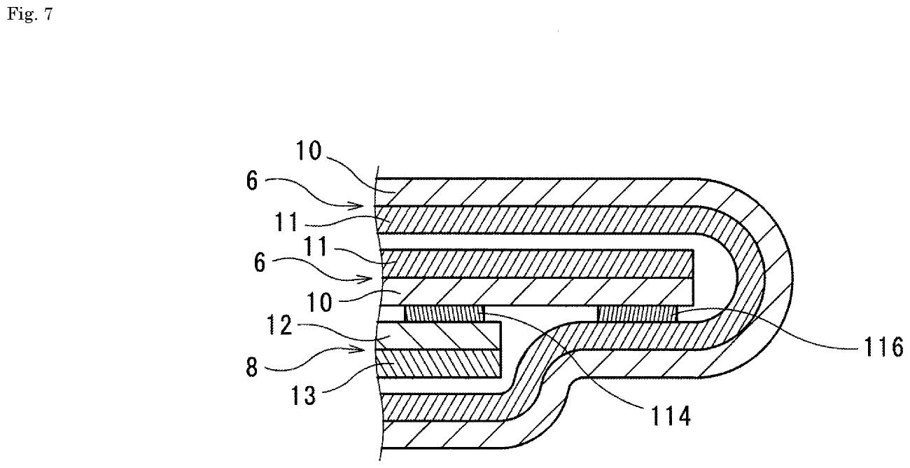

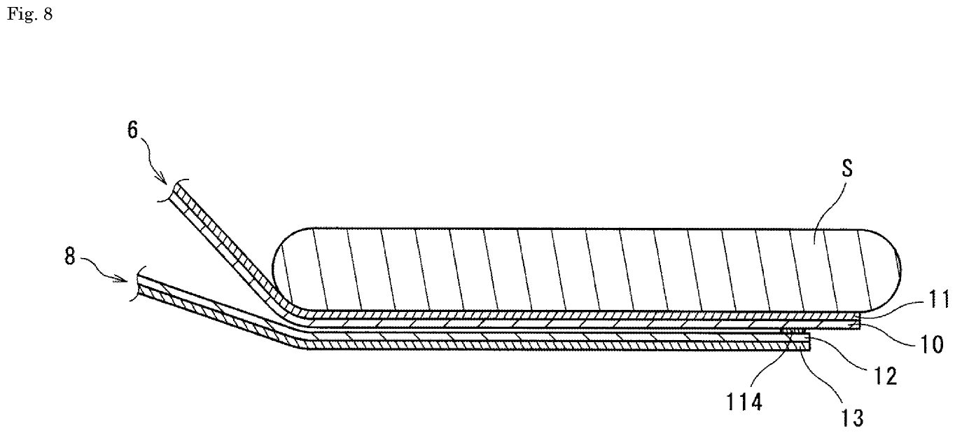

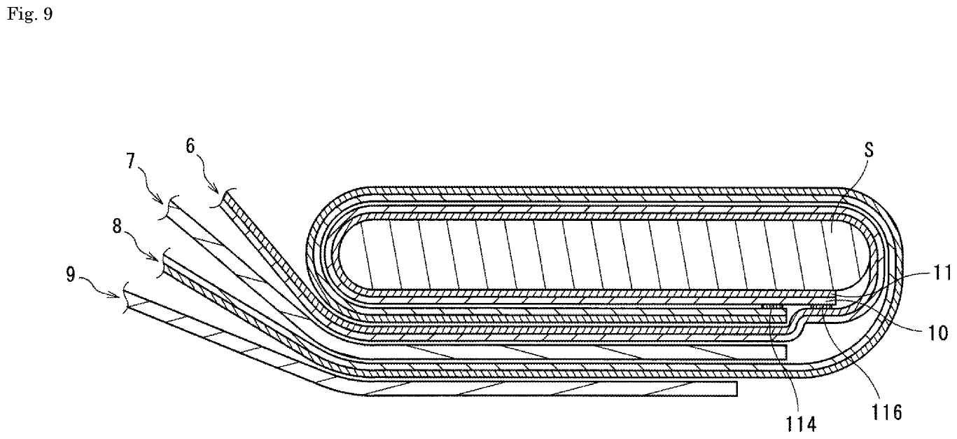

At the innermost periphery of the electrode assembly 102, at least a part of the first separator 6 and at least a part of the second separator 8 are bonded to each other. Unlike the electrode assembly 2 in FIG. 2, however, as shown in FIGS. 6 and 7, the substrate layer 10 of the first separator 6 and the substrate layer 12 of the second separator 8 are bonded to each other at tip parts 114 of the innermost periphery, with the tip of the second separator 8 being disposed so as to be shifted rearward with respect to the tip of the first separator 6. More specifically, the substrate layer 10 of the first separator 6 is exposed at the tip of the first turn (innermost circumference) based on the innermost circumference of the electrode assembly 102 (see FIG. 8). Thus, the surface of the layer 11 including the inorganic particles, of the first separator 6, for the second turn based on the innermost circumference, faces the surface of the substrate layer 10 of the first separator 6 for the first turn (see FIGS. 7 and 9). In the electrode assembly 102, facing parts 116 between the first separator 6 for the first turn and the first separator 6 for the second turn are bonded to each other. Specifically, the substrate layer 10 of the first separator 6 for the first turn and the layer 11 including the inorganic particles, of the first separator 6, for the second turn are bonded to each other. The method for bonding the facing parts 116 is also not particularly limited, but welding is preferable, and ultrasonic welding is more preferable.

As described above, in the energy storage device according to the second embodiment, the facing parts 116 between the first separator 6 for the first turn and the first separator 6 for the second turn based on the innermost circumference of the electrode assembly 102 are bonded to each other, thus making the winding of the electrode assembly 102 less likely to be loosened, and allowing winding deviations and the like to be further kept from being caused.

The electrode assembly 102 can be manufactured through a bonding step, a disposing step, a winding step and a removing step in accordance with the above-described method for manufacturing the electrode assembly 2. As with the method for manufacturing the electrode assembly 2, the order of the bonding step and the disposing step is not limited. In the bonding step, however, the substrate layer 10 of the first separator 6 and the substrate layer 12 of the second separator 8 are allowed to face each other, and the tip parts 114 are bonded to each other, with the tip of the second separator 8 being shifted rearward with respect to the tip of the first separator 6 (see FIG. 8). Also in the disposing step, with the tip of the second separator 8 being shifted rearward with respect to the tip of the first separator 6, the separators are disposed on the spindle S. In addition, in the winding step, as shown in FIG. 8, winding for the first turn is performed with only the first separator 6 and the second separator 8 disposed. Then, as shown in FIG. 9, the facing parts 116 between the first separator 6 for the first turn and the first separator 6 for the second turn are bonded to each other. In addition, for the second turn, the negative electrode 7 is disposed between the first separator 6 and the second separator 8, whereas the positive electrode 9 is disposed outside the second separator 8, and the first separator 6, the negative electrode 7, the second separator 8, and the positive electrode 9, layered in this order, are wound for the second and subsequent turns.

### <Energy Storage Device: Third Embodiment>

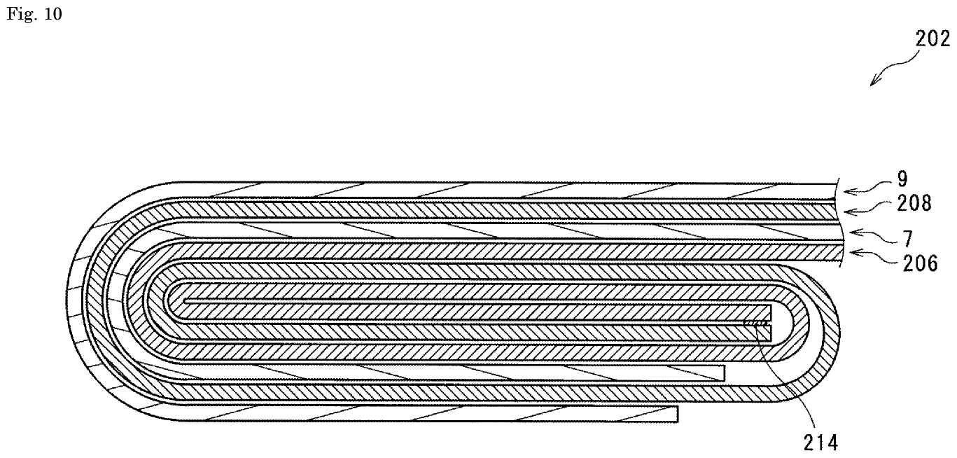

An energy storage device according to a third embodiment of the present invention includes an electrode assembly 202 shown in FIG. 10. The energy storage device according to the third embodiment is the same as the energy storage device according to the first embodiment, except for including the electrode assembly 202 in place of the electrode assembly 2.

As shown in FIG. 10, the electrode assembly 202 is a wound-type electrode assembly obtained by winding a first separator 206, a negative electrode 7 as a first electrode, a second separator 208, and a positive electrode 9 as a second electrode layered on each other in this order. In addition, the electrode assembly 202 has no winding core. The specific structures of the negative electrode 7 and positive electrode 9 included in the electrode assembly 202 are the same as those included in the electrode assembly 2 in FIG. 2.

The first separator 206 and the second separator 208 each have a band shape. The first separator 206 and the second separator 208 each have a single layer structure including a layer including inorganic particles. As described above, the electrode assembly 202 shown in FIG. 10 differs from the electrode assembly 2 shown in FIG. 2 in that the first separator 206 and the second separator 208 have the single layer structure.

The layers including the inorganic particles in the first separator 206 and the second separator 208 contain a resin as a main component. The content of the resin in the layers including the inorganic particles is preferably 50% by mass or more and 99% by mass or less, more preferably 60% by mass or more and 95% by mass or less. As the resin, the resins and the like exemplified as materials for the substrate layer 10 of the first separator 6 of the electrode assembly 2 can be used. As described above, the first separator 206 and the second separator 208 each have the single layer structure including the inorganic particles and containing a resin as a main component, thereby allowing the first separator 206 and the second separator 208 to be bonded to each other easily and with sufficient strength by welding or the like. In addition, the layer disposed at the innermost peripheral surface of the electrode assembly 202 is the layer including the inorganic particles (the first separator 206 that has the single layer structure), thus allowing, for example, the friction between the surface of the spindle and the innermost peripheral surface of the electrode assembly 202 to be sufficiently reduced. Further, also in the electrode assembly 202 shown in FIG. 10, tip parts 214 of the innermost periphery are bonded to each other, as with the electrode assembly 2 shown in FIG. 2. As another embodiment, as in the electrode assembly 102 in FIG. 6, the first separator 206 and the second separator 208 may be disposed such that the tips thereof are shifted from each other, and the first separator 206 for the first turn and the first separator 206 for the second turn, based on the innermost circumference, may be further bonded to each other.

In addition, the content of the inorganic particles in the layers including the inorganic particles, of the first separator 206 and the second separator 208, is preferably 1% by mass or more and 50% by mass or less, more preferably 5% by mass or more and 40% by mass or less. The content of the inorganic particles is equal to or more than the lower limit mentioned above, thereby allowing, for example, the friction between the surface of a spindle and the innermost peripheral surface of the electrode assembly 202 to be sufficiently reduced. In addition, the content of the inorganic particles is equal to or less than the upper limit mentioned above, thereby allowing the weldability and the like to be improved. As the inorganic particles, the same inorganic particles as those described for the energy storage device according to the first embodiment can be used.

The electrode assembly 202 can be manufactured through a bonding step, a disposing step, a winding step and a removing step in accordance with the above-described method for manufacturing the electrode assembly 2. As with the method for manufacturing the electrode assembly 2, the order of the bonding step and the disposing step is not limited.

### <Energy Storage Apparatus>

The energy storage device of the present embodiment can be mounted as an energy storage unit (battery module) configured by assembling a plurality of energy storage devices 1 on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique of the present invention may be applied to at least one energy storage device included in the energy storage unit.

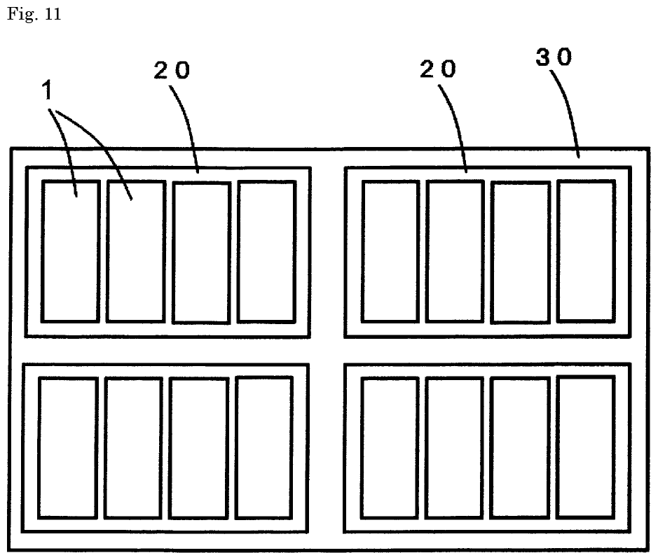

FIG. 11 shows an example of an energy storage apparatus 30 obtained by assembling energy storage units 20 that each have two or more electrically connected energy storage devices 1 assembled. The energy storage apparatus 30 may include a busbar (not shown) that electrically connects two or more energy storage devices 1, a busbar (not shown) that electrically connects two or more energy storage units 20, and the like. The energy storage unit 20 or the energy storage apparatus 30 may include a state monitor (not shown) that monitors the state of one or more energy storage devices.

### Other Embodiments

It is to be noted that the energy storage device according to the present invention is not to be considered limited to the embodiment mentioned above, and various changes may be made without departing from the scope of the present invention. For example, the configuration according to one embodiment can be added to the configuration according to another embodiment, or a part of the configuration according to one embodiment can be replaced with the configuration according to another embodiment or a well-known technique. Furthermore, a part of the configuration according to one embodiment can be deleted. In addition, a well-known technique can be added to the configuration according to one embodiment.

While the case where the energy storage device is used as a nonaqueous electrolyte secondary battery (for example, lithium ion secondary battery) that can be charged and discharged has been described in the embodiment mentioned above, the type, shape, size, capacity, and the like of the energy storage device are arbitrary. The present invention can also be applied to capacitors such as various secondary batteries, electric double layer capacitors, or lithium ion capacitors. In addition, the present invention can also be applied to an energy storage device in which the electrolyte is an electrolyte other than the nonaqueous electrolyte.

In the energy storage device according to the present invention, the second separator may be a separator including no layer including inorganic particles, unlike the above-mentioned embodiments. Examples of such a separator include a single-layer or multi-layer separator including no inorganic particles, such as a porous resin film or a nonwoven fabric. In addition, the first separator and the second separator may have a layer structure of three or more layers. The first separator and the second separator may be separators that differ in layer structure, material, and the like. In addition, according to the above-mentioned embodiments, the electrode assembly is obtained by winding the first separator, the negative electrode as a first electrode, the second separator, and the positive electrode as a second electrode, layered on each other in this order, but the negative electrode and the positive electrode may be inversed.

### INDUSTRIAL APPLICABILITY

The present invention can be applied to, for example, an energy storage device for use as a power source for automobiles, other vehicles, electronic devices, and the like.

### DESCRIPTION OF REFERENCE SIGNS

1: Energy storage device
2, 102, 202: Electrode assembly
3: Case
4: Positive electrode terminal
41: Positive electrode lead
5: Negative electrode terminal
51: Negative electrode lead
6, 206: First separator
7: Negative electrode (first electrode)
8, 208: Second separator
9: Positive electrode (second electrode)
10, 12: Substrate layer
11, 13: Layer including inorganic particles
14, 114, 214: Tip part
15: Innermost peripheral surface
116: Facing part between first separator for first turn and first separator for second turn
S: Spindle
20: Energy storage unit
30: Energy storage apparatus

1. An energy storage device comprising an electrode assembly obtained by winding a first separator, a first electrode, a second separator, and a second electrode layered in this order, without including a winding core,
wherein at least a part of the first separator and at least a part of the second separator are bonded to each other at an innermost periphery of the electrode assembly,
the first separator includes a substrate layer and a layer including inorganic particles,
the layer including the inorganic particles is disposed at an innermost peripheral surface of the electrode assembly, and
a surface of the substrate layer of the first separator for a first turn and a surface of the layer including the inorganic particles, of the first separator for a second turn, based on an innermost circumference, are layered to face each other, and the facing parts are bonded to each other.

2. The energy storage device according to claim 1, wherein the bonding between the first separator and the second separator is welding.

3. The energy storage device according to claim 1, wherein the first separator further includes a substrate layer containing a resin as a main component, and
at least a part of the substrate layer and at least a part of the second separator are bonded to each other at an innermost periphery of the electrode assembly.

4. The energy storage device according to claim 1, wherein the layer including the inorganic particles contains a resin as a main component.

5. (canceled)

6. A method for manufacturing an energy storage device, comprising:
bonding at least a part of a tip part of a band-shaped first separator including a substrate layer and a layer including inorganic particles and at least a part of a tip part of a band-shaped second separator to each other, with a tip of the second separator being shifted rearward with respect to a tip of the first separator;
disposing the tip part of the first separator and the tip part of the second separator on a spindle such that the layer including the inorganic particles has contact with the spindle;
performing winding for a first turn with use of the spindle, with only the first separator and the second separator disposed;
layering a surface of the substrate layer of the first separator for the first turn and a surface of the layer including the inorganic particles, of the first separator for a second turn, based on an innermost circumference, to face each other, and bonding the facing parts to each other;
disposing, for the second turn, a first electrode between the first separator and the second separator, and a second electrode outside the second separator, and winding the first separator, the first electrode, the second separator, and the second electrode stacked in this order for the second and subsequent turns; and
removing the obtained electrode assembly from the spindle.
